(19) United States
(12) Patent Application Publication
(10) Pub. No.: US 2024/0209280 A1
(43) Pub. Date: Jun. 27, 2024

(54) NOVEL PROCESS AND EQUIPMENT FOR SOLVENT FRACTIONATION

(71) Applicant: DESMET BELGIUM, Zaventem (BE)

(72) Inventors: Marc Kellens, Mechelen-Muizen (BE); Matthias Zick, Zaventem (BE)

(73) Assignee: DESMET BELGIUM, Zaventem (BE)

(21) Appl. No.: 18/287,219

(22) PCT Filed: Apr. 22, 2022
(86) PCT No.: PCT/US2022/026062

§ 371 Date: Oct. 17, 2023

Related U.S. Application Data
(60) Provisional application No. 63/178,267, filed on Apr. 22, 2021.

(51) Int. Cl. C11B 7/00; A23D 9/04; B04B 3/00; B04B 15/02; B04B 15/12

(52) U.S. Cl. CPC C11B 7/0025; A23D 9/04; B04B 3/00; B04B 15/02; B04B 15/12

(57) ABSTRACT

Process including the solvent crystallization of edible fatty material into a crystal slurry containing at least solid crystallized stearin dispersed into a solution composed solvent and olein, and further including the separation of the stearin from the solution by applying centrifugal forces onto the crystals slurry.

### CROSS-REFERENCE TO RELATED APPLICATIONS

This application claims priority to U.S. Provisional Patent Application Ser. No. 63/178,267, filed Apr. 22, 2021, and titled NOVEL PROCESS AND EQUIPMENT FOR SOLVENT FRACTIONATION, which is herein incorporated by reference in its entirety.

### FIELD OF THE INVENTION

The present invention generally relates to a new process and new apparatus for the solvent fractionation of edible fatty materials. In particular, when compared to current practices, the inventive process results in substantial energy savings by significantly reducing the solvent to fatty material ratio both during the crystallization step and during the phase separation step while simultaneously keeping, or in some instances increasing, the quality of the fractionated products (stearin and olein). Furthermore, the pieces of equipment used in the present invention are considerably more compact and less energy demanding than the pieces of equipment currently in use in the field of solvent fractionation of edible fatty materials.

### BACKGROUND OF THE INVENTION

Natural edible fatty materials are a mixture of various triglycerides containing different fatty acids moieties of different lengths and/or different saturation degrees. Consequently, those various triglycerides are characterized notably by different melting temperatures and can therefore be separated by a fractionation process based on their distinct crystallization temperatures. The result of fractionation is the production of two components, called fractions, that typically differ significantly from each other in their physical properties, notably their melting temperatures and their saturation degrees (measured by IV, i.e., Iodine Value). Usually, a first fraction will be solid at room temperature (the stearin) and a second fraction will be liquid at room temperature (the olein). There are two main types of fractionation techniques: dry fractionation and solvent fractionation. Dry fractionation refers to a process that does not use a solvent to assist in the separation of the fat components, while in solvent fractionation, the fatty material that will be fractionated is dissolved in a solvent, commonly acetone or hexane. A third type of fractionation process makes use of detergent but is rarely operated at present.

As a matter of fact, solvent fractionation of edible fatty materials is a niche process preferably used to produce high value specific food components such as for example cacao butter equivalents. The specialty fats market, in particular food formulations including high-end fat fractions from tropical oils, still makes use of solvent fractionation technology even if the dry fractionation is much more prevalent and more economical. The liquid fraction resulting from the solvent fractionation, often a super olein, has also more value than standard olein derived from dry fractionation. Dry fractionation is not sufficiently selective to produce, at least in a limited number of steps, cacao butter equivalents offering the expected narrow melting profile of true cacao butter.

In currently available solvent fractionation processes, the edible fatty material is solubilized in a rather large volume of solvent such as acetone or hexane and cooled to a temperature at which the components having the highest melting point, solidify as crystals, said crystals remaining dispersed in the un-crystallized lower melting components which remain dissolved in the solvent. This mixture is called the crystal slurry. When the crystallization cycle is completed, the solid crystals are then separated from the liquid phase to yield, after solvent evaporation, the stearin and the olein. In currently available solvent fractionation processes, the weight ratio between the solvent and the edible fatty material feedstock is usually comprised between about 3 to about 5 which requires large installations to handle such large volume of miscella and solvent. The use of solvents such as acetone or hexane requires that all the pieces of equipment used in the solvent fractionation process are explosion proof which includes at least the crystallization vessel(s), the phase separation equipment(s) and the solvent evaporation/distillation device(s). Indeed, the solvent must be entirely recovered and recycled which is energy intensive since it involves thermal evaporation.

Therefore, as both the initial investment and the operating expenses are markedly higher for solvent fractionation than for the dry fractionation, it is not surprising that the dry fractionation process, despite its lower performances, is by far much more prevalent in the industry.

One possibility to reduce both the initial investment and the operating expenses of a solvent fractionation facility would be to significantly reduce the amount of needed solvent per unit of fractionated edible material. Indeed, such reduction would directly impact the size of the installation, the energy necessary to cool the solvent and edible fatty material mixture, and the energy for the evaporation of the solvent from the fractionated products. As a matter of fact, with currently available technology, one must realize that the rather high ratio between the solvent and the edible fatty material is not really required by the crystallization step itself but is in fact required for obtaining an efficient separation of the crystal slurry into the olein and stearin fractions. Indeed, currently, this separation step is realized continuously on vacuum belt filters that are made explosion proof by encapsulation. Those vacuum belt filters require a very fluid crystal slurry to perform an acceptable separation, and such very fluid crystal slurry can only be attained if the crystals are dispersed in a rather large volume of solvent. Therefore, usually, the ratio of the solvent to the edible fatty material is about 3 to about 5, depending on various parameters such as, the crystallizer type, the separation method, the nature of the product to be fractionated and the desired specifications of the obtained fractions.

As a matter of fact, in a vacuum belt filter, the driving force for the phase separation is obtained with the partial vacuum created below the belt filter. This driving force is thus relatively moderate and is unable to efficiently separate viscous crystal slurries. Indeed, the vacuum achieved below the filter belt is usually in the range of 400 to 500 mbara which induces only a relatively weak filtration driving force. Supplementary significant disadvantages of vacuum belt filters are their bulky size, requiring large footprint, which is particularly penalizing in an explosion proof environment, and their high energy demand since the vacuum is constantly and inefficiently maintained in a large volume. Indeed, vacuum belt filters are affected by substantial leakage because the space below the moving belt where the vacuum is applied cannot be hermetically connected to the moving belt. Consequently, only a moderate vacuum is obtained despite the substantial electrical energy input. On top, once most of the miscella is removed, and the cake is formed, vacuum is lost, still leaving behind a significant amount of miscella in the stearin cake because cracks appear in the cake and those cracks cause the loss of vacuum. Thus, this leads to significant olein remaining in the stearin cake and significant solvent amount to be recovered by evaporation.

Nevertheless, notwithstanding those defects, the vacuum belt filter is currently extensively used in the field because it allows for the washing of the stearin cake laying on the belt with fresh solvent and has the secondary advantage of being continuous. Besides, no proven and performant alternative separation techniques are currently available.

Indeed, the washing of the stearin cake with fresh solvent is advantageous because it permits to further remove the olein from the stearin crystals cake, and thus, further contributes to the obtention of pure stearin commanding higher price. Any innovative separation technique should permit such washing of the stearin cake with fresh solvent and/or be sufficiently performant to make such washing superfluous. Thus, even if in general, the continuous filtration of the slurry is an advantage, the washing of the stearin cake with fresh solvent is even much more important than the continuous mode of operation offered by the vacuum belt filters, because such washing with fresh solvent further entrains the residual olein entrapped in the cake which results in a purer stearin of higher value.

Consequently, there is a need in the art for an improved crystal slurry separation technique, in particular a separation technique still allowing for the washing of the stearin cake with solvent but that additionally is able to separate efficiently viscous crystals slurry, and moreover requiring less energy and smaller footprint than the current separation technique used in the field of solvent fractionation.

Therefore, investigations have been initiated aiming at the reduction of the quantity of solvent used in the solvent fractionation process, and those investigations focused on techniques able to separate the solid stearin fraction from the liquid olein fraction solubilized in the solvent, with the requisite that the novel separation technique can be made explosion proof and allows for the washing of the stearin cake with solvent. For this reason, filter-presses, usually used in the dry fractionation process, are excluded. Indeed, even if this one could be made explosion proof by encapsulation, the washing of the stearin cake with solvent is not that straightforward in current filter-presses. On the contrary, centrifugal separators, even if currently, not used at manufacturing scale in the field of oil and fat fractionation, are available in explosion proof version and some models allow a washing of the collected cake with solvent.

Accordingly, several documents describing oils and fats fractionation processes involving various type of centrifuge separators have been reviewed. However, even if the possibility of using centrifugal separators is evoked since many decades, none of those documents would motivate the skilled artisan to use centrifugal separators for an industrial scale solvent fractionation process due to the absence of published convincing performances and, more deterrently, serious issues of centrifugal separators that are reported in those documents.

British patent specification No. 973,457 describes the use of a centrifugal separator in which the solids having a higher density than the oil accumulates at the periphery of the zone of centrifugation and are intermittently and automatically extruded outwardly through an opening in this periphery. However, this type of continuous centrifuge, often called nozzle centrifuge, does not allow for the washing of the stearin cake with fresh solvent. Furthermore, this document does not focus on solvent fractionation.

British patent specification No. 1,013,365 also mentions centrifuging as being theoretically a suitable separation method without specifying the type of centrifuge used and their performances. However, no separation result by centrifuge is shown and, furthermore the document is not focusing on solvent fractionation.

British patent specification No. 1,120,456, describes a centrifuging technique in which cooled oil containing suspended stearin, with a diluent such as hexane, is treated in a conventional centrifuge. The force applied is 1,000 g to 10,000 g. However, the conventional centrifuge described in British patent specification No. 1,120,456 does not allow for the washing of the solid stearin which is a requisite for the obtention of very pure stearin fraction. Furthermore, the document lends to the conclusion that high viscosity crystal slurries, thus crystal slurries containing a limited amount of solvent, would generate frictional effect causing a temperature rise during the separation leading to the melting of the stearin crystals. Such temperature rise makes centrifugal separation useless since the melting of the stearin crystals will ruin the upstream crystallization step. Indeed, upon melting, the liquid stearin will be ejected from the centrifuge and mixed with the olein, something that must be avoided at all costs.

The use of a conical centrifuge has been described in U.S. Pat. No. 4,542,036. In this invention, the solid stearin is separated from the liquid olein by centrifugal force and the solid stearin is further automatically conducted outside the conical centrifuge due to the angle made by the conical centrifuge. This angle is 45° or more relative to the direction of the centrifugal force so that the solid is not only subjected to a centrifugal force but also to a tangential force pushing the solid towards the exit. However, it is possible that in practice, the solid will not be regularly pushed toward the exit of the centrifuge because the advancement of the solid will be conditioned by the coefficient of friction between the solid and the centrifuge surface in contact with said solid material. This may even be more critical in case of solvent usage. Unfortunately, this irregular discharge of the conical centrifuge in not conductive of constant product quality which probably explain the commercial failure of this process. Furthermore, the washing of the stearin cake with pure solvent is not possible with this type of conical centrifuge because the cake is constantly moving and its residence time inside the conical centrifuge is very short (a few seconds).

Furthermore, U.S. Pat. No. 4,542,036 further reports that in a meeting of the American Oil Chemists Society in Chicago from 15th to 18th Oct. 1967, a paper was presented by D. D. Horton describing the use of batch basket centrifuges for separating solid stearin from olein. The crystal slurry is fed to the basket which is rotated and olein separates and flows though the screen. When a cake of stearin has accumulated, the machine is run for a time without further feed to drain the olein from the stearin cake, the latter is then discharged and the cycle recommenced. The solid stearin components in the basket are subjected to centrifugal forces for at least two minutes before discharge. However, U.S. Pat. No. 4,542,036 further reports that this technique does not appear to have been put into extensive commercial practice. The use of rotation speeds resulting in force of 450 g has been believed to lead to a rise in temperature and a consequent loss of stearin by melting, something that must be avoided at all costs. Therefore, U.S. Pat. No. 4,542,036 excludes the use of basket centrifuges in which the residence time is usually longer than two minutes. This residence time is not only relatively long for commercial practice, but combined to a possible rise in temperature, such long residence time may have catastrophic consequences on the melting of the stearin solid fraction annihilating all the benefits of the previous crystallization. The discontinuous aspect of a basket centrifuge is also deemed disadvantageous. For those reasons, U.S. Pat. No. 4,542,036 excludes the use of basket centrifuge as a technique of separation of the olein from the stearin.

U.S. Pat. No. 6,169,191 discloses the use of a nozzle-type centrifuge for the production of stearin from fat of animal or plant origin. The document is limited to the dry fractionation and the type of centrifuge described does not allow to wash the stearin cake with clean solvent.

Accordingly, even if many documents mention that, theoretically, the olein and the stearin could be separated by centrifugation, a detailed review of those documents would not incite a skilled artisan in solvent fractionation to seriously consider such separation technology. Indeed, the washing of the cake with clean solvent is not possible with standard centrifuges, conical centrifuges and bowl centrifuges. Furthermore, conical centrifuges may release the cake erratically which is not conductive to constant quality. In the case of basket centrifuges, it is reported that the combination of high viscosity crystal slurry and high g-forces lead to temperature increase which induce the melting of the stearin, something that must be avoided at all costs. Those deficiencies explain why, despite the potential usage of centrifuge separators such as basket centrifuges have been evoked as early as 1967, and even earlier for other types of centrifuges, to our knowledge, no industrial application has been realized yet. Instead, currently, in industrial scale fractionation plants, press-filters are omnipresent in the case of dry fractionation process and vacuum belt filters are ubiquitous in the case of solvent fractionation. In the latter case, such vacuum belt filters are made explosion proof and are totally encapsulated.

Thus, solvent fractionation is a speciality process allowing the production of high-quality food ingredients. Since the solvent is fully recovered and recycled, no effluent is created by solvent fractionation and therefore, solvent fractionation is a sustainable process. However, solvent fractionation, as currently performed is very energy intensive. On one hand, the demand in energy comes from the filtration of the crystal slurry using vacuum belt filter. Vacuum belt filters are widely used because they are made explosion-proof, the filtration of the crystal slurry is continuous, and it is possible to wash the crystals slurry with solvent in order to further displace olein entrapped between the stearin crystals. Hence, it is possible to obtain stearin of high purity. However, the constant holding of vacuum, in the large volume of the vacuum belt filter is very energy intensive. On the second hand, the demand in energy comes also from the solvent recovery from the produced fractions. This specific energy demand is thus directly proportional to the quantity of solvent used for a given quantity of processed feedstock, particularly the ratio of solvent in the crystal slurry and the residual solvent contained in the crystal cake obtained after the phase separation step. Thus, with the currently available technology, the washing of the crystal cake with solvent in a vacuum belt filter, which is advantageous quality-wise, is made at the expense of a large energy consumption and a very significant footprint.

Therefore, there is a need in the art for a new process and/or a new equipment for the solvent fractionation of edible oils and fats that is compact and reduces the energy demand compared to existing technologies. Furthermore, the properties of the fractionated products must be maintained or, even preferably, improved.

### OBJECT AND ADVANTAGES OF THE INVENTION

It is the object and advantages of the invention to disclose a process and/or equipment for the solvent fractionation of edible fatty materials requiring less energy, less footprint and producing fractionated products having at least similar properties compared to currently available solvent fractionation technologies. Additional advantages may become apparent from the detailed description of the present invention.

### BRIEF DESCRIPTION OF THE DRAWINGS

FIG. 1 is a schematical representation of a basket centrifuge of the peeler type particularly advantageous for the process according to the present invention.

FIG. 2 is a flowchart of the process according to the present invention.

FIG. 3 depicts a process for the solvent fractionation of edible fatty materials in accordance with an embodiment of the present invention.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### SUMMARY OF THE INVENTION

It has been surprisingly found that the above object can be achieved with a process for the solvent fractionation of edible fatty materials including the steps of: solubilizing the edible fatty material in a solvent to form a solution, cooling said solution to obtain a crystal slurry comprising at least two fractions i.e., a solid fraction made of crystals of stearin dispersed in a liquid fraction, said liquid fraction being made of olein dissolved in said solvent, conducting said crystal slurry in a basket centrifuge, spinning said basket centrifuge in a way to separate said crystal slurry into a solid fraction and a liquid fraction, said solid fraction forming a stearin cake inside the basket of said basket centrifuge, and said liquid fraction being ejected by centrifugal forces and collected, optionally washing said stearin cake with solvent and/or weak miscella while still spinning the basket centrifuge, and collecting the stearin cake, said process being characterized in that the temperature of said stearin cake formed in the basket of said basket centrifuge is not increased by more than 5° C. compared to the temperature of the crystal slurry conducted in said basket centrifuge.

It has been further surprisingly found that the above object can be achieved with a process as previously described wherein said basket centrifuge is not cooled by an external cooling means.

It has been further surprisingly found that the above object can be achieved with a process as previously described wherein said basket centrifuge is connected to an external cooling means.

It has been further surprisingly found that the above object can be achieved with a process as previously described wherein said basket centrifuge is a peeler basket centrifuge.

It has been further surprisingly found that the above object can be achieved with a process as previously described wherein said basket centrifuge is a pusher basket centrifuge.

It has been further surprisingly found that the above object can be achieved with a process as previously described wherein said basket centrifuge operates at various centrifugal forces (or g-forces) during stearin cake formation, washing step(s) and final spinning.

It has been further surprisingly found that the above object can be achieved with a process as previously described wherein said step e) does not include the washing of said stearin cake with pure solvent.

It has been further surprisingly found that the above object can be achieved with a process as previously described wherein said step e) includes one washing step of said stearin cake with solvent such as pure solvent or weak miscella.

It has been further surprisingly found that the above object can be achieved with a process as previously described wherein said step e) includes two or more washing steps of said stearin cake with solvent such as pure solvent and/or weak miscella(s).

It has been further surprisingly found that the above object can be achieved with a process as previously described wherein said step e) includes two or more washing steps of said stearin cake, said washing steps being realized in a counter-current mode i.e., where a miscella obtained from a washing step is used as washing solvent for an upstream washing step and where pure solvent is used for the last washing step.

It has been further surprisingly found that the above object can be achieved with a process as previously described wherein said step c) includes an ATEX certified basket centrifuges.

It has been further surprisingly found that the above object can be achieved with a process as previously described wherein said spinning of the basket centrifuge corresponds to a centrifugal force comprised between 50 g and 2000 g.

### DEFINITIONS

Edible fatty materials. In the context of the present invention the terms “edible fatty materials” designate edible oils or fats, or blends thereof, from vegetal or animal origin, composed essentially of triglycerides. Those edible fatty materials entering the process according to the present invention are usually refined and may already have undergone previous fractionation process(es), in particular one or more dry fractionation process(es), and/or other processes such as interesterification and/or hydrogenation. Edible fatty material entering the present process may also be the results of blends of various edible fatty materials where at least one component of the blend has been previously modified by one or more modification process(es) such as fractionation, interesterification and/or hydrogenation.

Slurry (or crystal slurry): in the context of the present invention the term(s) “slurry”, or “crystal slurry” refer(s) to a mixture of crystals of edible fatty materials dispersed in liquid solution of olein solubilized in a solvent. In current solvent fractionation technologies, the solvent to edible fatty material ratio is usually about 4 to about 5 in order to obtain a non-viscous crystal slurry able to be filtered on vacuum belt filter. According to the present invention this ratio can be reduced to about 2-3 and even to about 1-2 because basket centrifuges used in the present invention are able to more efficiently separate viscous slurry. Therefore, the slurry produced in the present invention is more concentrated in fatty material and therefore the derived olein solution obtained after the centrifugation according to the present invention contains significantly less solvent and thus less solvent must be evaporated resulting in substantially less energy demand compared to available technologies.

Solvents. In the context of the present invention the term “solvents” refers for example to acetone, hexane, alcohol, halogenated hydrocarbons or any blends of two or more solvents. In the context of the present invention, the term “solvents” may also refer to solutions or miscellas containing essentially pure solvent (such as acetone, hexane etc.) and small amount of fatty material, usually olein. Typically, such solutions or miscellas, when containing a small quantity of fatty material can be used as solvent to solubilize a large quantity of fatty material or can be used as washing liquid, especially to wash the stearin cake. When used for such purposes, those solutions or miscellas contain preferably only a few percent of fatty material or even less than 1 percent of fatty material. In the field, such solutions are often referred as weak miscellas.

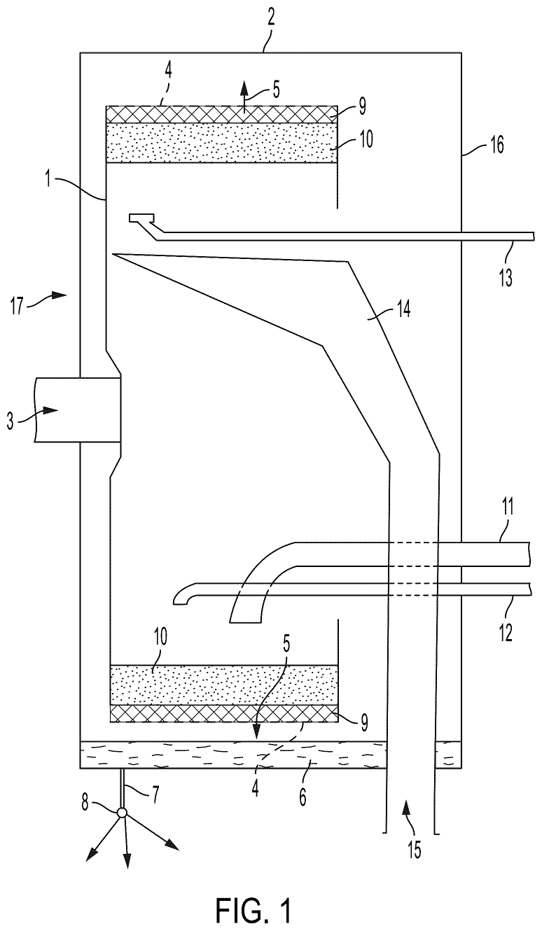

Basket centrifuges. In the context of the present invention the terms “basket centrifuges” designate a family of centrifuges permitting to wash the filtrate with for example solvent. Preferred basket centrifuges are of the peeler types where the filtrate accumulate in the basket and are discharged discontinuously but such discharge can be realized automatically with adequate means such as for example a peeler knife, conveyor and the proper automation. In peeler centrifuge, the basket usually contains a filter cloth material. However, the present invention is not limited to this type of basket centrifuge and satisfactory results can be obtained with for example pusher centrifuges which is a type of basket centrifuge where the filtrate accumulating in the basket is continuously discharged from said basket. Pusher centrifuge' basket usually do not contain filter clothes and are therefore more adapted for separating crystal slurries containing crystals of large size. However, basket centrifuges of other types and not listed in this section can be useful for the present invention and are explicitly included. A schematical representation of a peeler basket centrifuge 17, as a cross-section at the center of the basket 1, is represented on FIG. 1. It has a rotating basket 1 enclosed in a hermitical holding vessel 2. The basket 1 is put in rotation by a shaft 3 actioned by a drive motor (not shown). The basket is provided with perforations 4 to allow the passage of solvent and/or miscella 5 which accumulate 6 at the bottom of the holding vessel when the basket is spinning. The accumulated solvent and/or miscella 6 can be drained via a duct 7 which can be fitted with a multi-way valve 8 allowing to segregate solvent or miscella of various strength in various holding tanks (not shown). Then, the segregated miscellas or various strength can optionally be recycled for their own merits, for example as washing medium. The basket is equipped with clothe material 9 of appropriate porosity retaining solids, in the form of a cake 10. The slurry is introduced in the basket, typically with slurry pipe 11. Typically, the slurry is feed to the basket when this one is rotating which results in the immediate formation of a cake and the ejection of miscella/solvent. Fresh solvent or weak miscella can be introduced via a washing pipe 12 and sprayed on the cake. Upon final spinning and the draining of most of the solvent/miscella from the cake, this one can be scrapped with a knife 13 and collected in a hopper 14 and conducted outside the holding vessel via duct 15. The downstream handling of the collected cake must take into account its content in solvent. The slurry pipe 11, washing pipe 12 and knife can optionally slide and be tilted. Proper sealing means between those elements and the holding vessel must be used to maintain the hermeticity. Furthermore, door(s) and/or window(s) are preferably installed on the right side 16 (operator side) of the holding vessel for inspection. It is directly apparent that this configuration allows the automatic feeding of a crystal slurry, its separation into a cake and a miscella, the one or more washing of the cake and the collection of the final cake.

Active cooling means. Active cooling means, also known as external cooling means or an active external cooler, includes typically commercial industrial refrigerating units or industrial chiller units able to maintain the temperature within a specified range. For example if the set point is 10° C., the external cooling means will be able to maintain the temperature of the centrifuge at an average temperature of 10° C. (within the range of for example 8° C. to 12° C.) by circulating in closed loop a thermo-regulated fluid (for example water or a water/propylene-glycol blend) in the basket centrifuge. Many suppliers make such equipment available such as for example Carrier (US), Daikin Industries (JP), Ingersoll Rand (IE), Johnson Controls (US), Mitsubishi Electric (JP). As a matter of fact, the skilled artisan in the field of oils and fats fractionation will, in general, be familiar with external cooling means equipment since fractionation is based on the accurate control of the temperature.

### DETAILED DESCRIPTION OF THE INVENTION

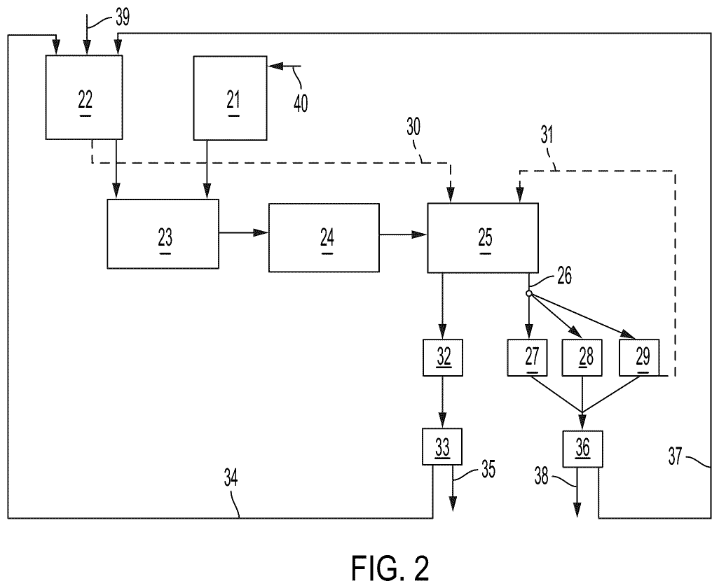

The above object can be achieved with process using for example basket centrifuge of the peeler type as illustrated by FIG. 1. The steps of the innovative process are illustrated on the flowchart shown on FIG. 2.

Edible fatty material 21 is mixed with a solvent 22 to form a solution 23. This solution 23 is conducted in a crystallizer 24 and cooled to obtain a crystal slurry comprising at least two fractions i.e., a solid fraction made of crystals of stearin dispersed in a liquid fraction, said liquid fraction being made of olein dissolved in said solvent. The resulting slurry is conducted to at least one basket centrifuge 25 which, upon spinning, separates said crystal slurry into a solid fraction and a liquid fraction, said solid fraction forming a stearin cake inside the basket of said basket centrifuge, and said liquid fraction (miscella) being ejected by centrifugal forces and conducted 26 to one or more holding vessels 27, 28, 29. Optionally the stearin cake, can be washed with solvent 30 and/or weak miscella 31 while still spinning the basket centrifuge.

The (optionally washed) stearin cake is then optionally collected in a holding vessel 32 and conducted to a desolventizer 33 for the recovery of the solvent which is recycled 34 and the obtention of the final stearin 35. Similarly, the one or more miscellas are collected and conducted to a desolventizer 36 to recover the solvent which is recycled 37 and the final olein 38. Of course, some solvent loss is unavoidable and thus new solvent must be constantly supplied 39. Constant supply of fatty material must be provided as well 40.

Technical documentations from centrifuge separators manufacturers report that an accurate temperature control of a centrifuge makes necessary to actively refrigerate it to counteract the heat being produced during centrifugation because centrifugation is in fact an exothermic process. For example, the two following recommendations can be found respectively on the public website of two centrifuge separator manufacturers at the following addresses (at the time of the redaction of the present specification):
https://www.researchgate.net/institution/Eppendorf_AG/post/5abb9b9cdc332daeb b0cd1a1_How_Cool_is_your_Refrigerated_Centrifuge: “Centrifugation involves spinning samples fast which builds up physical forces and releases heat. Standard centrifuges are capable of managing the temperature in the bowl, but their effectiveness depends on the design of the centrifuge. If you want to actively and accurately control the temperature in a centrifuge, it needs to be refrigerated to counteract the heat being produced. Placing a centrifuge in a cold room may help negate this but it will not provide reproducible and accurate cooling of your samples. Therefore, refrigeration built into the centrifuge is the only way to confidently protect your samples and ensure they are kept at the desired temperature. Do not forget to leave a gap around your centrifuge to allow for heat dissipation, particularly where the cooling vents are located, and keep it away from other equipment with high heat outputs.”
https://ortoalresa.com/en/products/guide-for-selecting-equipment/temperature-control-cooling-and-heating/: “Centrifugation is an exothermic process which produces heat by friction with the air in the centrifuge chamber and the different parts of the rotor. This heat depends on multiple factors such as the type of rotor, room temperature or set speed.”

The reported potential temperature increase occurring during centrifugation explains why, despite some documents mention this separation technology in the field of edible oil fractionation, it was never seriously investigated for industrial edible fatty material fractionation facilities. Indeed, it is paramount to maintain the temperature during the phase separation of the crystal slurry. The perceptive of an increase in temperature that would lead to the melting of the stearin and would ruin the previous crystallization step is an absolute deterrent to any skilled artisan engaged in the field of oils and fats fractionation.

In contrast, the assurance that the temperature of the crystal slurry can be maintained constant on a belt filter explains the success of this technology in the field of solvent fractionation. Even if some friction-heat may occur, this one will be very limited because only low viscosity crystal slurries are treated, and the separation speed is rather low inducing thus low internal frictions. Furthermore, any moderate heat generation that may occur is compensated by the evaporative cooling effect due to partial solvent evaporation triggered by the vacuum created beneath the belt filter. However, since no vacuum is created in basket centrifuges, no cooling relying on this phenomenon can be expected which is particularly damageable since the friction-heat generated in a centrifuge separator is expected to be significant because the driving force is high and furthermore, purposely, higher-viscosity crystal slurries are processed in order to reduce the solvent ratio. It must be pointing out that this problem is even more accurate in the case of explosion proof centrifuges since then, the centrifuge vessel must be totally hermitical. In conclusion, a closer study of the merits of centrifugal separators reveals that they are particularly unfit as separation technology of crystal slurries, in particular viscous crystal slurries containing a reduced amount of solvent.

Despite those contrary evidence on their utility, solvent fractionation based on a particular centrifugal separation type has been thoroughly investigated and, most surprisingly, it has been found possible to perform centrifugal separations of crystal slurries with basket centrifuges that are superior to those realized with the reference vacuum belt filter. Furthermore, the innovative fractionation process is more economical than the reference one based on vacuum belt filter.

It has surprisingly been found that when the crystal slurry obtained by a solvent crystallization step is separated in a basket centrifuge, a substantial reduction of energy and solvent per processed fatty material weight unit is observed and, despite the failure predicted by prior art and technical documents, no substantial temperature increase is observed even if the basket centrifuge is not equipped with active cooling means. By no substantial temperature increase it is meant that the temperature increase, if any, does not lead to the melting of the stearin crystal and is limited to a maximum of 5° C. compared to the temperature of the crystal slurry entering the basket centrifuge. The temperature of the crystal slurry entering the basket centrifuge is typically identical to the final crystallization temperature imposed to said crystallization slurry in the one or more crystallization vessel(s).

Even more surprisingly, it has been observed that, compared to current separation technology, in particular vacuum driven filtration, stearin cake containing less olein and considerably less solvent is obtained by using the novel process disclosed in the present invention. The stearin cake resulting from the conventional separation processes like vacuum belt filtration, contains more residual olein and solvent than the one obtained by the present innovative process.

Thus, it has been surprisingly found that a better separation of the crystal slurry can be achieved by basket centrifuges than the one obtained by conventional vacuum filtration and that, consequently, purer stearin fractions are obtained. Furthermore, those fractions contain significantly less solvent.

Consequently, the stearin cake contains less entrapped olein as compared to the stearin cake obtained by conventional vacuum filtration, hence less cake washing is required, which results in a lower overall solvent need. Additionally, residence time of the crystal slurry in the basket centrifuge is limited to a few minutes (typically about 1 to about 15 minutes).

Even if such a residence time is quite long according to most centrifugal separation technologies, it still allows commercially advantageous throughputs of the products. A surprising aspect of the present invention is the realization that, contrary to what is reported in prior art documents, no significant temperature increases of the crystal slurry occur during such relatively long residence time and consequently, there is no risk that part of the solid stearin melts during the centrifugal separation.

The invention is particularly advantageous for the production of cocoa butter equivalent, and even more particularly in the case of the production of cocoa butter equivalent from a product know in the field as Soft Palm Mid Fraction (SPMF) obtained by two successive palm oil dry fractionation steps. Since SPMF is the results of two successive dry fractionations, any supplementary fractionation becomes much more difficult and, as a matter of fact, dry fractionation is not able to perform a third fractionation step on SPMF to achieve the desired quantity and quality of hard palm mid fraction (HPMF) used to substitute cocoa butter or to substantially improve its physical melting properties. Only solvent fractionation will be able perform a selective third fractionation step on such material. Our invention is also particularly advantageous for the production of cocoa butter equivalent directly starting from olein of IV 56.

Thus, it has been surprisingly observed that, contrary to what is reported in many documents, no substantial temperature increase has been observed even for centrifugation cycles of several minutes and that no melting of the stearin crystals occurs during the centrifugal separation realized according to the present invention. However, this observation is not fully understood. Without willing to be bound to any theory, this surprising observation could be explained by the evaporation of a small fraction of the solvent during the spinning of the centrifuge under the influence of the high centrifugal forces. This evaporation could reduce the temperature of the crystal slurry to compensate, at least partially, for the temperature increase due to unavoidable frictional forces generated during any centrifugal separation. This effect could explain why temperature increases are reported when attempting the centrifugal separation of crystal slurries obtained by dry fractionation. Thus, the process according to the present invention preferably includes basket centrifuges equipped of solvent venting outlet(s) in order to allow for the evacuation of any evaporated solvent. Optionally, the vent(s) can be connected to a vacuum device. Of course, care must be paid to recover any vented solvent and to design vent(s), vacuum and recovery means according to explosion proof standards. As a matter of fact, this option would be a substantial deviation of current practice since usually explosion proof centrifuge are operated at moderate overpressure.

Of course, another design pre-requisite is to ascertain that the centrifuge selected in the process according to the present invention does not transmit heat to the basket from its engine, drive and/or gearings or from any other sources.

According to one embodiment of the present invention, the centrifugal separation of the crystal slurry is essentially discontinuous, in particular when basket centrifuges of the peeler type are selected. However, the intrinsic disadvantage of a discontinuous mode of separation is greatly reduced with the possibility to automatize the feeding of the crystal slurry into the basket centrifuge, its centrifugation including its washing with solvent, and its discharge from basket centrifuge. Thus, even if not continuous, the operation of the basket centrifuge can be automatized and does not require the constant attention and involvement of production operators. Furthermore, two or more basket centrifuges can work in parallel resulting in a nearly continuous separation. For example, when three basket centrifuges are operated in parallel, they can be coordinated to feed the first basket centrifuge with crystal slurry while the second basket centrifuge is centrifuging and washing, and the third basket centrifuge is discharging a stearin cake. Then, the first centrifuge will be centrifuging and washing, the second basket centrifuge will discharge the stearin cake and the third centrifuge will be fed with new crystal slurry. Next, the first centrifuge will be discharging the stearin cake, the second will be fed with a new crystal slurry, and the third will be centrifuging and washing. This sequence is then repeated continuously. This set-up is particularly advantageous in case of continuous solvent crystallization and since the separation is nearly continuous, the crystal slurry resulting from the continuous crystallization is not stored for long period of time and therefore its consistency is maintained.

According to another embodiment of the present invention, the centrifugal separation of the crystal slurry is continuous, in particular when basket centrifuges of the pusher types are selected for the separation of the crystal slurry. However, typically, pusher centrifuges are usually equipped of basket made of relatively coarse metallic grid and require thus large crystals to perform a selective and efficient phase separation. Thus, the use of pusher centrifuges is advantageous when the crystal slurry contains essentially large crystals obtained mostly from particular fatty materials and/or particular solvent crystallization conditions favorizing large stearin crystals.

The invention requires Appareils destinés à être utilisés en ATmosphères EXplosibles (ATEX) certified basket centrifuges, preferably basket centrifuges of the peeler type or basket centrifuges of the pusher type for feedstocks and/or crystallization conditions generating large crystals. Good results have been obtained with centrifuges supplied by Heinkel (Germany) and Rotabel (France), but it is expected that ATEX certified basket centrifuges supplied by other suppliers, if correctly sized and correctly operated, will be useful for the invention. One important feature to assess is the capacity of the basket centrifuge to be operated without communicating any residual heat from their engine or from their gearings to the basket containing the crystal slurry. This would be highly detrimental as it may cause the melting of the stearin cake and hence ruins any separation process. When a basket centrifuge of the peeler type is used for the present invention, care should also be taken to choose suitable cloth material having the appropriate porosity. This cloth material fits inside the basket of the peeler centrifuge and can be removed easily for inspection, washing or replacement. Good results have been observed with PP monofilament filter cloth (50 μm pore size), but the invention is not limited to this type of cloth material. As a general rule, the cloth type and porosity must be adapted to the size of the crystals contained in the slurry which usually depends on the fatty material processed and the selected crystallization process and equipment. Baskets centrifuge, totally made of metal, preferentially stainless steel, are preferred. Indeed, since the basket centrifuge units are installed preferably in a controlled temperature area, any heat generated during the centrifugation will be easily conducted by the metallic structure of the basket centrifuge and dissipated in the controlled temperature area. Such mechanism is less efficient if structural part of the basket centrifuge is realized in thermoplastic or other heat isolating materials. The present invention can make use of both horizontal and vertical basket centrifuges. Generally, horizontal basket centrifuges are preferred because the filter cake forms with a more constant thickness. This allows a more effective cake washing even with slurries that are difficult to filter. A vertical basket centrifuge usually is limited to slurries with good cake formation properties. For the cake removal, the horizontal machines require a chute or a discharge screw. The vertical basket centrifuges discharge into a bottom hopper which is simple and reliable.

The average residence time of the crystal slurry in the basket of the centrifuge usually ranges from about 50 to about 5000 seconds, preferably from about 200 to about 2000 seconds and even more preferably from about 400 to about 1000 seconds, including the optional one or more solvent washing steps. If no washing step is needed, the residence time will be significantly reduced. The feeding and discharge duration directly depends on the size of the installation but rarely exceed about 100 seconds when those steps are automated and optimized. In the case of pusher basket centrifuges, the residence time is usually shorter because the separation of slurry containing large crystals is easier and faster. Furthermore, baskets of pusher basket centrifuges are usually more porous than those of peeler basket centrifuges. Minimization of the residence time is an important parameter for the productivity of the process according to the present invention. It is also advantageous to minimize the residence time to further reduce any risk of temperature increase of the crystal cake contained in the basket of the centrifuge. Furthermore, excessive residence time may reduce the yield of the separation process since, the ingress of small stearin crystals could be, in some circumstances, favorized. Thus, it is advantageous to the process to discharge the crystal cake as soon as its target properties are reached. In practice, the residence time is determined empirically for any new type of crystal slurry to be separated. Once established, an excellent repeatability has been observed.

In general, higher centrifugal forces will deliver stearin cake of higher purity because high centrifugal force will increase the expelling of the solvent and the olein from the cake while the solid stearin crystal cake remains in the basket of the centrifuge. However, simultaneously, high centrifugal force may have a tendency to reduce the yield of the separation, particularly if this one contains a large proportion of small stearin crystals. Indeed, the smaller stearin crystals will be more prone to ingress through the basket's pores if the applied centrifugal force is elevated. Thus, there is a balance to be found between selectivity and yield. The skilled artisan is aware of this aspect for many separation technologies and will apply his knowledge to optimize the present invention when applied to a particular case. Therefore, it is to be understood that the g-force values discussed below are related to our particular experiments and that variations to those values are expected when the present invention involve significantly different fatty materials and/or significantly different crystallization conditions and/or significantly different centrifuge separators. However, the values and trends presently disclosed will guide the skilled artisan to rapidly select the optimal centrifugal forces to be applied during the phase separation step according to the present invention. It should be understood that the easy variation of the centrifugal force is highly advantageous as it introduces an additional parameter in the separation process. As a matter of fact, in the present inventive process, the basket centrifuge can operate at various g-forces during stearin cake formation, washing step(s) and final spinning and such parameter does not exist for currently available separation techniques presently used in solvent fractionation of edible oils and fats.

The preferred centrifugal force applied during the separation of the crystal slurry is at least about 50 g to about 1500 g. However, the optimal centrifugal force may vary significantly according to the separation progression. Preferably, moderate centrifugal forces are applied during the feeding of the crystal slurry into the basket. Best results have been observed with a force of about 300 g during the feeding of the crystal slurry. In particular, it has been observed that a moderate centrifugal force applied during the feeding and optionally at the beginning of the centrifugal separation proper is conductive of higher yield. Preferably a force of about 200 g to about 500 g is applied during the spinning and/or washing phase. Optionally, a final spin, just before the discharge of the stearin cake may be applied with a force preferably ranging from about 500 g to about 1500 g. The final spin under high centrifugal force may enhance the removal of the last trace of solvent and/or olein and thus lead to the production of a very pure stearin. However, the higher the centrifugal force the higher the risk of decreasing the yield (some small stearin crystals may ingress through the basket). Another risk possibly associated to very high centrifugal forces is an increase of temperature. Indeed, even if it has been observed that, surprisingly, no substantial increase of the temperature of the crystal slurry has been detected, attention must still be paid to the circumstances that may favor such temperature increase, and extremely high centrifugal force is one of them. The characteristics of the fractionated fatty materials, the target specifications of the final products, the crystallization conditions and the centrifuge separator type will of course modulate the centrifugal forces to be applied. However, surprisingly, those centrifugal forces are generally considerably lower than the one applied for other family of centrifuges. Centrifugal force ten times higher are reported for other centrifuges which are not of the basket type. As a matter of fact, for liquid/liquid separation in typical centrifuges, high g force is usually needed and is a key parameter. A basket centrifuge typically operates a solid/liquid separation and the g force and the liquid ring above the filter cake may create a filtration pressure. The compact structure of crystal slurry will retain the olein and/or the miscella. The filtration pressure and the g force may collaborate to remove more efficiently the olein/miscella from the crystal slurry since the pressure is pushing and the g-force is pulling. The combination of those parameters is not fully understood and could be synergetic.

According to the present invention, the ratio of the solvent to edible fatty material that is fractionated can be reduced to 3 and even below. Accordingly, the resulting slurry is considerably more viscous but nonetheless, its separation in a basket centrifuge remains possible and fully satisfactory fractions are obtained. In sharp contrast, if the separation of such viscous slurry is realized on a vacuum belt filter, this separation is less efficient and a substantial fraction of olein and more solvent remains in the stearin cake. Hence, the stearin is less pure and has therefore less value and furthermore less olein fraction is obtained, and more energy is necessary to evaporate the residual solvent contained in both fractions. For efficient filtration on a vacuum belt filter, it is needed to increase the solvent to edible fatty material ratio to at least 3 or more in order to obtain a non-viscous slurry easy to filter. Consequently, the process according to the present invention is highly advantageous since less solvent is used which means considerably less energy is needed to evaporate said solvent. Additionally, substantially less energy is needed for cooling the slurry since its volume is significantly reduced. Additionally, the significant volume reduction of the slurry makes possible the utilization of crystallizers of smaller size which reduces the investment and the footprint significantly.

In the process according to the present invention, less washing solvent is required for the washing of the stearin cake that has accumulated in the basket centrifuge. It has been surprisingly observed that stearin fractions having satisfactory purity can be obtained with only one washing cycle and even with no washing cycle. In contrast, two or more washing cycles are necessary when the stearin cake is obtained with a vacuum based filtration. This observation is totally unexpected and due to the superior efficiency of basket centrifuge. The reduction of the washing has a direct impact on the productivity since associated with a significant reduction of the residence time. Furthermore, if the slurry is prepared with pure solvent, less solvent will be processed. However, in practice, in many solvent fractionation facilities, the liquid resulting from the washing cycles contain a low amount of fatty material and therefore those liquids are directly used as solvent to dissolve the fatty material entering the fractionation process. In the present invention, when more than one washing cycles are realized, those washing may be realized in a counter-current mode, i.e. with miscella from a given washing step used as washing solvent for a previous washing step and with pure solvent at the last washing step. The very weak miscella obtained from this last washing step being thus used as a washing liquid in a upstream washing. Such counter-current mode of washing of the stearin cake also contributes to the overall reduction of needed solvent.

Those cumulative advantages make the process according to the present invention significantly more competitive than alternative separation techniques, in particular those one based on vacuum filtration.

The following examples serve to further illustrate the invention. However, the present invention is not limited by those examples but will be limited only by the claims.

### EXAMPLES

### Experiments Conditions

Technical grade acetone and SPMF (Soft Palm Mid Fraction) sourced from major Belgium suppliers were used as solvent and starting fatty materials for all the solvent fractionation experiments. The sourced SPMF is fully representative of a starting material in solvent fractionation facilities. Its properties are summarized in Table 1.

ATEX crystallizer associated to a Julabo FP50 programmable cooling bath was used for the production of all crystal slurries. The ATEX crystallizer was a pilot Contube of a capacity of 15 L supplied by Desmet Ballestra (Belgium).

A thermoregulated ATEX pressure vessel contained the washing solvent (technical acetone) which was maintained at a temperature of 6° C.

Two ATEX basket centrifuges (peeler type) have been used: V 400 TP ATEX from Heinkel (Germany) equipped with PP monofilament filter cloth basket (corresponding to about 50 μm pore size) and RC 30 ATEX from Robatel (France) equipped with PP filter cloth removable baskets. Two types corresponding respectively to a pore size of about 25 μm and about 50 μm have been investigated (BP001208-1 SAC 05-1001-SK025 and BP001208-1 SAC 05-1020-K046). Those two basket separators are designated respectively BCS 1 and BCS 2 in the following discussions (for Basket Centrifuge Separator 1 & 2).

Vacuum based filtration was realized with a double-jacketed stainless steel Büchner filter, covered with Larox PB 627 B Monofilament filter cloth (50 μm pore size, Permeability: 240 l/dm²·min). The same type of filter cloth is frequently used in large scale vacuum belt filter. The vacuum applied below the filtration surface was about 50 mbara. This laboratory equipment is a fair simulation of a vacuum belt filter. As a matter of fact, usually, less vacuum is applied below the filtration surface of industrially used vacuum belt filters.

Solvent crystallization started with the melting of SPMF and its mixing in the crystallizer vessel with acetone with an acetone/SPMF ratio of 3/1 (weight/weight). This solution was first kept at 30° C. in a fully melted state for 30 min to erase any pre-existing crystals. After this initial rest time at 30° C., the mixture was rapidly cooled at 13° C. in 15 min and then cooled more slowly up to 6° C. in 150 min. When the temperature reached 6° C. it was maintained at this temperature during 15 min. The total crystallization time is 180 min after the initial isotherm of 30 min at 30° C. A mechanical agitation was maintained at 40 rpm during the full crystallization time. Directly after the crystallization, the obtained crystal slurry was split in two parts, the first part undergoing a separation by basket centrifugation and the second part undergoing a separation by vacuum filtration. Thus, the comparison of the two separation techniques is realized on the same batch of crystal slurry and hence unbiased results are obtained.

Vacuum filtration was realized with the Buchner filter systematically maintained at a temperature of 6° C. and with an internal vacuum maintained at about 50 mbara. A controlled amount of slurry was deposited on the Buchner filter equipped with filter cloth and the filtration was maintained for 2 minutes. After this initial filtration, the resulting cake was optionally washed with pre-cooled acetone at 6° C. The weight of the acetone used for those optional washing steps equals the weight of the SPMF used in the crystallization step. Directly after the filtration and the optional washing(s), the analyses were undertaken on both the stearin cake and the olein.

All Basket centrifugations separations were realized with a basket centrifuge placed at least 8 hours in a controlled temperature area set at 6° C. in order to fully equilibrate its temperature. However, the basket centrifuges used in the experiments were not equipped with active cooling means. Then a controlled amount of slurry having a temperature of 6° C. is introduced in the basket centrifuge and centrifuged in different conditions of centrifugal force, duration, and ramp-up. The formed cake was optionally followed by one or two washing(s) with pre-cooled acetone at 6° C. Most of those washings were realized with a quantity of acetone corresponding to the weight of the crystallized SPMF. Some washings realized when evaluating the separation performances given by BCS2, have been realized with less acetone with the aim of determining the impact of this parameter. Directly after the centrifuge separation and the optional washing(s), the analyses are undertaken on both the filtrate and the retentate.

TABLE 1
Properties of the SPMF used as starting fatty material.

| Parameters | SPMF |
|---|---|
| FFA [%, as C16:0] | 0.13 |
| Elements via ICP [ppm] | |
| P | 1.0 |
| Ca | 0.07 |
| Mg | 0.08 |
| Na | 1.0 |
| K | 0.7 |
| Fe | N.D. |
| Fatty acids via GLC [%] | |
| C12:0 | 0.1 |
| C14:0 | 0.9 |
| C15:0 | 0.04 |
| C16:0 | 49.4 |
| C16:1t | 0.02 |
| C16:1c | 0.1 |
| C17:0 | 0.1 |
| C17:1 | 0.02 |
| C18:0 | 4.8 |
| C18:1t | 0.03 |
| C18:1c | 37.4 |
| C18:2t | 0.2 |
| C18:2c | 6.4 |
| C18:3t | 0.04 |
| C18:3c | 0.1 |
| C20:0 | 0.3 |
| C20:1 | 0.06 |
| SFA | 55.7 |
| MUFA | 37.6 |
| PUFA | 6.7 |
| Trans FA | 0.2 |
| IV, Calculated [gl₂/100 g] | 44.1 |
| IV, Wijs [gl₂/100 g] | 44.8 |
| DAG/TAG via HPLC [%] | |
| DAG | 5.0 |
| LLO | 0.2 |
| PLL | 1.2 |
| MLP | 0.5 |
| OOL | 0.8 |
| POL | 5.1 |
| PLP | 9.5 |
| MPP | 0.2 |
| OOO | 1.8 |
| POO | 12.3 |
| POP | 50.7 |
| PPP | 0.7 |
| SOO | 1.3 |
| POS | 9.2 |
| PPS | 0.1 |
| SOS | 1.1 |
| PSS | N.D. |
| SSS | 0.1 |
| UUU | 2.8 |
| StUU | 19.9 |
| StUSt | 70.9 |
| StStSt | 1.2 |

N.D.: Not detectable

### Example 1

The consistency of the performances delivered by different separation technologies and different basket centrifuge manufacturers has been assessed. Table 2, Table 3 and Table 4 respectively report the results obtained for crystal slurries separated by different basket centrifuge separators (BCS 1 and BCS 2) and by vacuum filtration. The phase separation with BCS 1 were realized with a feeding and spin centrifugal force of 300 g, a final spin centrifugal force of 1200 g and 2 washing steps. The results corresponding to Trials 1C, 2C and 3C were obtained for the same process parameters which permitted to assess the repeatability of the separation performance given by BCS 1. The results show a very good repeatability with minimal variation in product quality and yield. In trial 1C the cake thickness was slightly below expectation. It is possible that this observation was due to an unknown manipulation inaccuracy because this evaluation series corresponds to one of the first utilization of BSC1. Indeed, such result was not observed again in any of the following trials. However, globally, the repeatability of the results is clearly observed. Furthermore, the properties of the resulting fraction are in-line with the general expectations awaited in the field of solvent fractionation of typical SPMF and were obtained without searching to optimize the performances since the goal was only to assess the consistency of the results delivered by the technology. Therefore, it is expected that the separation performances and the properties of the resulting stearin and olein fractions could be further improved by the optimization of several parameters such as the centrifugal forces applied in the various stages of the centrifugal separation (notably the feeding, washing, spinning, optional final spin at high centrifugal force), the progressivity of said applied centrifugal force for each of those stages, as well as their respective durations. In theory, the duration of the vacuum filtration can be adjusted, as well as the applied vacuum. However, in industrial practice, the maximum vacuum that the installation can deliver is chosen because, by definition, it corresponds to the best separation achievable by this technology and it is known that, in general, longer filtration does not improve any properties of the separated fractions. The only adjustable parameters left are the porosity of the filter cloth and the washing parameters. But those adjustable parameters are also available to optimize the centrifugal separation. It must be noted that in the case of basket centrifuge, the basket cloth can be easily and rapidly replaced by another one of different porosity. Changing the filter cloth of a vacuum belt filter is more time consuming. Finally, the temperature of the stearin cake accumulated in the basket centrifuge was constant at 6° C. and thus no temperature increase has been observed even if no active cooling means was connected to the centrifuge.

TABLE 2
Separation performances of three separation trials realized
with BCS 1 for constant experimental conditions.

| BCS 1 Centrifuge | Trial 1C | Trial 2C | Trial 3C |
|---|---|---|---|
| Olein fraction | | | |
| POO [%] | 26.2 | 26.1 | 26.8 |
| POP [%] | 20.2 | 22.1 | 22.0 |
| IV GC [—] | 59.3 | 58.5 | 58.4 |
| Stearin cake | | | |
| Cake thickness [mm] | 12 | 20 | 17 |
| Solvent retention [kg/kg] | 0.8 | 0.7 | 0.8 |
| Weight yield [%] | 59.0 | 58.8 | 60.1 |
| Calc. yield, IV GC [%] | 58.2 | 56.9 | 57.5 |
| POP recovery [%] | 82.3 | 80.2 | 80.7 |
| POO [%] | 2.0 | 2.1 | 2.4 |
| POP [%] | 71.7 | 71.4 | 71.1 |
| IV GC [—] | 33.2 | 33.2 | 33.6 |

Separation performances and repeatability obtained with BCS 2 are reported in Table 3. Two comparative trials in the same conditions have been realized (Trial T1 and Trial T3). For comparative purpose, the performances obtained with BSC1 and with vacuum filtration are also reported (Trial 8C and Trial VF1). All the separations were realized with 1 washing step using the usual quantity of solvent, i.e., a washing acetone/SPMF ratio of 1/1 (w/w).

TABLE 3
Separation performances and consistency
of various separation technologies.

| | BCS2 | | BCS1 | VF |
|---|---|---|---|---|
| | Trial T1 | Trial T3 | Trial 8C | Trial VF1 |
| Trial parameters | | | | |
| Feed spin [g] | 200 | 200 | 95 | — |
| Wash spin [g] | 300 | 300 | 470 | — |
| Final spin [g] | 800 | 800 | 800 | — |
| Vacuum [mbarg] | — | — | — | −100 |
| Filter cloth porosity [μm] | 50 | 50 | 50 | 50 |
| Olein fraction | | | | |
| POO [%] | 24.1 | 23.5 | 26.3 | 28.2 |
| POP [%] | 27.8 | 28.9 | 22.5 | 20.4 |
| IV GC [—] | 53.5 | 54.0 | 58.7 | 57.8 |
| Stearin cake | | | | |
| Cake thickness [mm] | 40 | 35 | 40 | 35 |
| Solvent retention [kg/kg] | 0.9 | 0.9 | 1.0 | 1.5 |
| Weight yield [%] | 55.3 | 52.1 | 60.7 | 71.8 |
| Calc. yield, IV GC [%] | 47.0 | 48.8 | 60.4 | 59.0 |
| POP recovery [%] | 64.7 | 66.9 | 82.6 | 79.4 |
| POO [%] | 3.4 | 3.4 | 3.3 | 4.1 |
| POP [%] | 69.7 | 69.4 | 69.3 | 68.2 |
| IV GC [—] | 33.5 | 33.7 | 34.6 | 34.6 |

The results obtained with the BSC2 were very repeatable and broadly comparable to the ones of the BSC1 and the vacuum filtration in terms of stearin quality. However, the olein quality (high POP), POP recovery and stearin yield were poorer. However, the parameters of the centrifuge separation realized with BCS2 were not optimized since the goal of the experiment was merely to assess the consistency of its separation performance. To this respect, the consistency is excellent. Those results are shown in table 3.

For comparative purpose, the consistency of the separation performance given by vacuum filtration has been assessed for fixed conditions and for one or two washing steps. The results are summarized in Table 4. While generally, the consistency provided by vacuum filtration is acceptable, this one remains clearly inferior to the consistency delivered by basket centrifuges.

TABLE 4
Consistency of the separation performances realized with vacuum filtration (50
mbara) for one or two washing steps (all other parameters being kept constant).

| | Trial | Trial | Trial | Trial | Trial | Trial | Trial | Trial |
|---|---|---|---|---|---|---|---|---|
| Vacuum Filtration | 1VF | 3VF | 5VF | 6VF | 8VF | 9VF | 11VF | 12VF |
| Washing steps | 2 | | 1 | | 1 | | 2 | |
| Olein fraction | | | | | | | | |
| Miscella conc. [%] | | | | | | | | |
| Filtrate | 14.2 | 13.4 | 12.5 | 14.7 | 13.4 | 13.0 | 13.2 | 13.5 |
| Wash 1 | 7.8 | 12.2 | 13.2 | 11.2 | 9.6 | 9.4 | 10.1 | 10.0 |
| Wash 2 | 8.9 | 7.5 | — | — | — | — | 6.7 | 7.6 |
| Weight yield [%] | | | | | | | | |
| Filtrate | 13.7 | 13.6 | 11.1 | 12.1 | 16.1 | 20.2 | 14.6 | 14.4 |
| Wash 1 | 11.5 | 10.8 | 13.1 | 14.3 | 10.0 | 8.9 | 8.8 | 11.7 |
| Wash 2 | 7.9 | 5.4 | — | — | — | — | 7.5 | 6.6 |
| POO [%] | 26.5 | 27.5 | 27.9 | 28.3 | 28.3 | 28.6 | 27.1 | 26.6 |
| POP [%] | 19.7 | 20.4 | 18.2 | 18.8 | 19.5 | 18.7 | 20.9 | 21.4 |
| IV GC [—] | 59.8 | 59.7 | 60.2 | 60.2 | 60.0 | 60.8 | 59.0 | 59.3 |
| Stearin cake | | | | | | | | |
| Cake thickness [mm] | 20 | 25 | 20 | 28 | 20 | 20 | 20 | 22 |
| Solvent retention [kg/kg] | 1.8 | 2.0 | 2.3 | 2.5 | 1.9 | 1.8 | 1.7 | 1.8 |
| Weight yield [%] | 70.6 | 68.8 | 75.7 | 76.7 | 74.3 | 70.4 | 67.7 | 68.9 |
| Calc. yield, IV GC [%] | 61.0 | 62.1 | 70.3 | 72.6 | 69.1 | 68.9 | 59.7 | 58.8 |
| POP recovery [%] | 84.1 | 84.2 | 88.7 | 89.9 | 87.7 | 88.1 | 82.8 | 83.0 |
| POO [%] | 3.0 | 3.5 | 6.0 | 6.7 | 5.7 | 5.4 | 2.8 | 2.3 |
| POP [%] | 69.8 | 68.7 | 63.9 | 62.7 | 64.3 | 64.8 | 70.2 | 71.5 |
| IV GC [—] | 34.1 | 34.6 | 37.4 | 38.0 | 37.0 | 36.6 | 34.1 | 33.5 |

### Example 2

Table 5 reports the separation performances obtained with BCS1 for trials realized with different centrifugal forces. All other parameters were kept constant at the exception of the number of washing steps. The first series of results were obtained for one washing step and the second series of results were obtained with two washing steps. Any washing step was realized with the usual quantity of solvent, i.e., a washing acetone/SPMF ratio of 1/1 (w/w).

TABLE 5
Influence of the centrifugal force.

| BCS 1 Centrifuge | Trial 3C | Trial 11C | Trial 5C | Trial 6C | Trial 9C | Trial 10C |
|---|---|---|---|---|---|---|
| Trial parameters | | | | | | |
| Feed spin [g] | 300 | 100 to 300 | 300 | 300 | 470 | 100 to 300 |
| Wash spin [g] | 300 | 470 | 300 | 300 | 470 | 470 |
| Final spin [g] | 1200 | 800 | 600 | 800 | 800 | 800 |
| # Wash steps | 2 | 2 | 1 | 1 | 1 | 1 |
| Olein fraction | | | | | | |
| POO [%] | 26.8 | 26.6 | 27.5 | 27.1 | 24.0 | 27.1 |
| POP [%] | 22.0 | 21.9 | 20.7 | 20.9 | 27.2 | 20.8 |
| IV GC [—] | 58.4 | 58.3 | 59.0 | 59.0 | 56.3 | 59.2 |
| Stearin cake | | | | | | |
| Cake thickness [mm] | 17 | 18 | 21 | 19 | 15 | 17 |
| Solvent retention [kg/kg] | 0.8 | 0.9 | 1.0 | 0.8 | 0.7 | 0.9 |
| Weight yield [%] | 60.1 | 56.5 | 64.9 | 65.8 | 55.3 | 61.4 |
| Calc. yield, IV GC [%] | 57.5 | 53.9 | 62.5 | 61.0 | 54.0 | 58.9 |
| POP recovery [%] | 80.7 | 78.7 | 85.2 | 83.2 | 75.5 | 82.0 |
| POO [%] | 2.4 | 1.1 | 3.4 | 3.4 | 2.6 | 2.7 |
| POP [%] | 71.1 | 73.9 | 69.1 | 69.1 | 70.8 | 70.5 |
| IV GC [—] | 33.6 | 32.0 | 35.2 | 34.6 | 33.7 | 33.6 |

The results summarized in table 5, indicate that increasing the final centrifugal force from 600 g to 800 g (Trial 5C vs. Trial 6C) had no significant influence on the HPMF yield or quality. Immediate spinning with high centrifugal force at 470 iso 300 g (Trial 9C vs. Trial 6C) resulted in very dry, uniform cake of excellent quality (almost 71% vs. 69% POP). This quality increase, however, was obtained at the expense of significant yield loss and reduced POP recovery which is defined as the percentage of available POP going into the HPMF fraction. This reduced POP recovery, in combination with the observed olein quality (lower IV, higher POP) indicates some passing of crystals through the filter basket (at the initial stages of centrifugation). However, this issue could be solved with the selection of basket cloth of smaller porosity, or by applying even more progressively the initial centrifugal force after the feeding of the crystal slurry into the basket of the centrifuge separator. As a matter of fact, gradual increase of the centrifugal force (Trials 10C and 11C vs. Trial 9C)—where the cake is formed at 100 g, spun from this value to 300 g with a gradual increase, washed at 470 g with final spin at 800 g—reduced the yield loss and increased POP recovery, while the quality remained similar. This observation confirms that since basket centrifugation offers many adjustable process parameters, satisfactory results can be expected for most crystal slurries obtained by solvent fractionation.

### Example 3

Table 6 reports the separation performances obtained with BCS1 for trials realized with different cake thickness. All the other parameters were kept constant.

TABLE 6
Influence of the cake thickness.

| Vacuum Filer and | Trial | Trial | | | | |
|---|---|---|---|---|---|---|
| BCS 1 Centrifuge | 11VF | 10VF | Trial 5C | Trial 8C | Trial 10C | Trial 12C |
| Olein fraction | | | | | | |
| POO [%] | 27.1 | 27.6 | 27.5 | 26.3 | 27.1 | 26.0 |
| POP [%] | 20.9 | 19.6 | 20.7 | 22.5 | 20.8 | 23.1 |
| IV GC [—] | 59.0 | 59.7 | 59.0 | 58.7 | 59.2 | 58.5 |
| Stearin cake | | | | | | |
| Cake thickness [mm] | 20 | 50 | 21 | 40 | 17 | 35 |
| Solvent retention [—] | 1.7 | 2.4 | 1.0 | 1.0 | 0.9 | 0.9 |
| Weight yield [%] | 67.7 | 65.7 | 64.9 | 60.7 | 61.4 | 58.8 |
| Calc. yield, IV GC [%] | 59.7 | 62.4 | 62.5 | 60.4 | 58.9 | 58.9 |
| POP recovery [%] | 82.8 | 84.1 | 85.2 | 82.6 | 82.0 | 81.7 |
| POO [%] | 2.8 | 3.5 | 3.4 | 3.3 | 2.7 | 2.8 |
| POP [%] | 70.2 | 68.3 | 69.1 | 69.3 | 70.5 | 70.3 |
| IV GC [—] | 34.1 | 34.7 | 35.2 | 34.6 | 33.6 | 34.1 |

Results obtained with the vacuum filtration (Trial 11VF and Trial 10VF), indicate that a thicker cake induces a slower filtration, higher cake solvent retention, higher yield, higher POP recovery and a slight decrease of the HPMF quality. Results obtained with the centrifugation reveal, surprisingly, an opposite trend. Slightly lower yield and POP recovery were observed, possibly due to some POP passing through the filter cloth. However, the overall effect on the product quality was very limited. This behavior could be solved with filter cloth of smaller porosity and/or adjustments of other process parameters offered by basket centrifuges. Therefore, it can be concluded that the productivity of basket centrifuges in an industrial facility is very promising since it can cope with thick crystal slurries efficiently.

### Example 4

A series of centrifugal separations with BSC1 and vacuum filtrations were realized and focused at determining the specific influence of the number of washing step(s). The vacuum filtration and the centrifugal separation tests were realized with no, one or two washing steps. The washing solvent volume corresponded, as usual, to a ratio washing acetone/SPMF 1/1 (w/w). Those results are reported in table 7.

TABLE 7
Influence of the cake thickness.

| Vacuum Filer and | | | | | | |
|---|---|---|---|---|---|---|
| BCS 1 Centrifuge | Trial 4VF | Trial 5VF | Trial 1VF | Trial 4C | Trial 6C | Trial 1C |
| Washing steps | 0 | 1 | 2 | 0 | 1 | 2 |
| Olein fraction | | | | | | |
| Miscella conc. [%] | | | | | | |
| Filtrate | 13.0 | 12.5 | 14.2 | — | — | — |
| Wash 1 | — | 13.2 | 7.8 | — | — | — |
| Wash 2 | — | — | 8.9 | — | — | — |
| Weight yield [%] | | | | | | |
| Filtrate | 14.3 | 11.1 | 13.7 | — | — | — |
| Wash 1 | — | 13.1 | 11.5 | — | — | — |
| Wash 2 | — | — | 7.9 | — | — | — |
| POO [%] | 27.9 | 27.9 | 26.5 | 26.8 | 27.1 | 26.2 |
| POP [%] | 20.2 | 18.2 | 19.7 | 20.9 | 20.9 | 20.2 |
| IV GC [—] | 59.1 | 60.2 | 59.8 | 59.1 | 59.0 | 59.3 |
| Stearin cake | | | | | | |
| Cake thickness [mm] | 30 | 20 | 20 | 20 | 19 | 12 |
| Solvent retention [—] | 1.1 | 2.3 | 1.8 | 0.8 | 0.8 | 0.8 |
| Weight yield [%] | 85.7 | 75.7 | 70.6 | 65.1 | 65.8 | 59.0 |
| Calc. yield, IV GC [%] | 69.1 | 70.3 | 61.0 | 63.0 | 61.0 | 58.2 |
| POP recovery [%] | 86.6 | 88.7 | 84.1 | 83.2 | 83.2 | 82.3 |
| POO [%] | 6.2 | 6.0 | 3.0 | 4.4 | 3.4 | 2.0 |
| POP [%] | 63.5 | 63.9 | 69.8 | 66.9 | 69.1 | 71.7 |
| IV GC [—] | 37.4 | 37.4 | 34.1 | 35.3 | 34.6 | 33.2 |

After vacuum filtration with no washing step, the HPMF yield was high (70%), but of poor quality (IV 37.4, POP 63.5%). One washing step had limited effect on the HPMF quality with an increase of about 0.5% POP to about 1.0% POP. The second washing brought the POP content close to 70% and IV ˜34. During the basket centrifugation trials, the number of washings had a more gradual influence on the HPMF quality. For the trials realized at 300 g (4C/6C/1C), the POP content increased from about 67% to about 69% to almost about 72% with each additional washing step. At higher spin rates (10C/11C), 70.5% POP was reached with 1 washing step and almost 74% after 2 washing steps. In general, after each wash step, the HPMF yield and POP recovery decreased, with the exception of test 5VF. This could be due to the poorer filtration and higher solvent retention.

### Example 5

A last series of centrifugal separations with BSC1 and vacuum filtrations were realized with the specific goal to compare their performance for optimized separation conditions as established in the previous examples. Furthermore, the influence of the number of washing steps was also investigated. The filtration tests were realized with one or two washing steps. The centrifugal separation tests were realized with no, one or two washing steps. The washing solvent volume corresponded, as usual, to a ratio washing acetone/SPMF 1/1 (w/w). The results are detailed in table 8.

TABLE 8
Comparison of the performance given by vacuum filtration
and centrifuge separation in optimized process condition.

| Vacuum Filer and | Trial | Trial | Trial | | | | |
|---|---|---|---|---|---|---|---|
| BCS 1 Centrifuge | 8VF1 | 11VF | 10VF | Trial 4C | Trial 3C | Trial 12C | Trial 11C |
| Trial parameters | | | | | | | |
| # Wash steps | 1 | 2 | 2 | 0 | 1 | 1 | 2 |
| Vacuum [mbarg] | −50 | −50 | −50 | — | — | — | — |
| Feed spin [g] | — | — | — | — | 300 | 100/300 | 100/300 |
| Wash spin [g] | — | — | — | — | 300 | 470 | 470 |
| Final spin [g] | — | — | — | — | 800 | 800 | 800 |
| Olein fraction | | | | | | | |
| POO [%] | 28.3 | 27.1 | 27.6 | 26.8 | 26.8 | 26.0 | 26.6 |
| POP [%] | 19.5 | 20.9 | 19.6 | 20.9 | 22.0 | 23.1 | 21.9 |
| IV GC [—] | 60.0 | 59.0 | 59.7 | 59.1 | 58.4 | 58.5 | 58.3 |
| Stearin cake | | | | | | | |
| Cake thickness [mm] | 20 | 20 | 50 | 20 | 17 | 35 | 18 |
| Solvent retention [—] | 1.9 | 1.7 | 2.4 | 0.8 | 0.8 | 0.9 | 0.9 |
| Weight yield [%] | 74.3 | 67.7 | 65.7 | 65.1 | 60.1 | 58.8 | 56.5 |
| Calc. yield, IV GC [%] | 69.1 | 59.7 | 62.4 | 63.0 | 57.5 | 58.9 | 53.9 |
| POP recovery [%] | 87.7 | 82.8 | 84.1 | 83.2 | 80.7 | 81.7 | 78.7 |
| POO [%] | 5.7 | 2.8 | 3.5 | 4.4 | 2.4 | 2.8 | 1.1 |
| POP [%] | 64.3 | 70.2 | 68.3 | 66.9 | 71.1 | 70.3 | 73.9 |
| IV GC [—] | 37.0 | 34.1 | 34.7 | 35.3 | 33.6 | 34.1 | 32.0 |

Under the selected and optimized tests conditions and as usual, realized on the same crystal slurry, it can be concluded that the overall performances given by basket centrifugation is better than those given by vacuum filtration. For example, it is observed that for the same amount of washing steps, the POP content of the collected stearin is about 2% to about 5% higher, its content of POO is about 1% to 2% lower and its IV is about 2 units lower. When one washing step is realized, good quality stearin (HPMF) having a POP content of about 70% can be produced with basket centrifugation. The same quality necessitates 2 washing steps with vacuum filtration. Under optimized conditions and with 2 washing steps, stearin having a content of about 70% POP and an IV of about 34 can be obtained via vacuum filtration, but those basket centrifugations realized in optimized condition and with 2 washing steps as well permit to obtain a stearin of better quality having a content of about 74% POP and an IV 32. Such quality increase is significant. However, in terms of POP recovery, i.e., the amount of POP from the crystal slurry that is recovered in the stearin fraction, the vacuum filtration scores better than the basket centrifugation, especially when high centrifugal forces are used during the basket centrifugation. This observation is due, mainly at the start of centrifugation, to the ingress of some of the smaller crystals through the filter cloth fitting in the basket of the centrifuge. Since the separation driving force is constantly low in a vacuum filter, the ingress of some of the smaller crystals through the filter cloth is less market. Optimization of the centrifugal force ramp-up and/or basket cloth porosity will resolve this behavior. Even, if not directly linked to the intrinsic quality of the recovered stearin, it must be pointed out that, systematically, the solvent retention of said stearin cake is advantageously significantly lower when obtained by basket centrifugation.

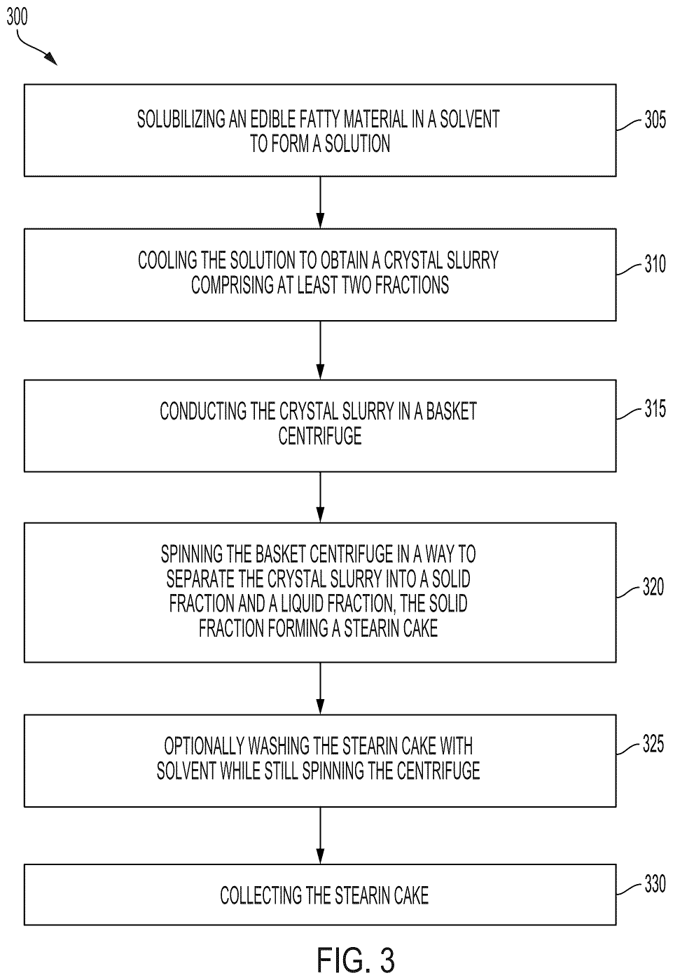

FIG. 3 depicts a process 300 for the solvent fractionation of edible fatty materials in accordance with an embodiment of the invention described above. In 305, an edible fatty material is solubilized in a solvent to form a solution. In 310, the solution is conducted in a crystallizer 24 and cooled to obtain a crystal slurry having at least two fractions. The at least two fractions include a solid fraction made of crystals of stearin dispersed in a liquid fraction made of olein dissolved in the solvent. In 315, the crystal slurry is conducted to a basket centrifuge 25. In some embodiments, the basket centrifuge 25 is a peeler basket centrifuge. In other embodiments, the basket centrifuge 25 is a pusher basket centrifuge. In some embodiments, the basket centrifuge 25 is an ATEX certified basket centrifuge. In some embodiments, the basket centrifuge 25 is not cooled by an external cooling means. In other embodiments, the basket centrifuge 25 is connected to an external cooling means.

In 320, the basket centrifuge 17 is spun to separate the crystal slurry into the solid fraction and the liquid fraction. The solid fraction forms a stearin cake in the basket 1 of the basket centrifuge 17. The liquid fraction (miscella) is ejected from the basket 1 by centrifugal forces (g-forces) and collected typically at the bottom of the hermitical holding vessel 2 to be conducted through duct 7 to one or more holding vessels via a multi-way valve 8. In an embodiment, the centrifugal forces can be between about 50 g and 2000 g.

In 325, optionally, the stearin cake obtained in 320 is washed while still spinning the centrifuge 17. Therefore, in some embodiments of process 300, the stearin cake obtained in 320 is washed, but in other embodiments the stearin cake obtained in 320 is not washed. In some embodiments, the stearin cake is washed once in 325 using solvent. The solvent can be pure solvent and/or weak miscella(s). In other embodiments, the stearin cake is washed twice in 325 using solvent. In additional embodiments, when the stearin cake is washed two or more times in 325, counter-current mode washing is used. In some embodiments, during said counter-current mode, a miscella obtained from the washing step is used as washing solvent for upstream washing step(s) and where pure solvent is used for the last washing step.

In some embodiments, the basket centrifuge 17 operates at various centrifugal forces (g-forces) during stearin cake formation, optional washing step(s), and final spinning.

In 330, the stearin cake is collected from the centrifuge 17. The temperature of the stearin cake formed in 320 is not increased by more than 5° C. compared to the temperature of the crystal slurry conducted in the centrifuge 17 in 315. Stated alternatively, the temperature of the stearin cake formed in 320 is not greater than 5° C. when compared to the temperature of the crystal slurry conducted in the centrifuge 17 in 315.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention. Combinations of the above embodiments and other embodiments will be apparent to those of skill in the art upon studying the above description and are intended to be embraced therein. Therefore, the scope of the present invention is defined by the appended claims, and all devices, processes, and methods that come within the meaning of the claims, either literally or by equivalence, are intended to be embraced therein.

1. A process for the solvent fractionation of edible fatty materials comprising the steps of:
a) solubilizing an edible fatty material in a solvent to form a solution,
b) cooling said solution to obtain a crystal slurry comprising at least two fractions, wherein said at least two fractions is comprised of a solid fraction made of crystals of stearin dispersed in a liquid fraction made of olein dissolved in said solvent,
c) conducting said crystal slurry in a basket centrifuge,
d) spinning said basket centrifuge in a way to separate said crystal slurry into said solid fraction and said liquid fraction, said solid fraction forming a stearin cake inside the basket of said basket centrifuge, and said liquid fraction being ejected by centrifugal forces (g-forces) and collected,
e) optionally washing said stearin cake obtained in step d) with solvent while still spinning the centrifuge,
f) collecting the stearin cake,
wherein the temperature of the stearin cake formed in step d) is not increased by more than 5° C. compared to the temperature of the crystal slurry conducted in said centrifuge in step c).

2. The process according to claim 1 wherein said basket centrifuge is not cooled by an external cooling means.

3. The process according to claim 1 wherein said basket centrifuge is connected to an external cooling means.

4. The process according to claim 1 wherein said basket centrifuge is a peeler basket centrifuge.

5. The process according to claim 1 wherein said basket centrifuge is a pusher basket centrifuge.

6. The process according to claim 1 wherein said basket centrifuge operates at various centrifugal forces (g-forces) during stearin cake formation, optional washing step(s) and final spinning.

7. The process according to claim 1 wherein said step e) does not include the washing of said stearin cake with pure solvent.

8. The process according to claim 1 wherein said step e) includes one washing step of said stearin cake with solvent such as pure solvent and/or with weak miscella(s).

9. The process according to claim 1 wherein said step e) includes two washing steps of said stearin cake with solvent such as pure solvent and/or with weak miscella(s).

10. The process according to claim 1 wherein said step e) includes two or more washing steps of said stearin cake, said washing steps being realized in a counter-current mode.

11. The process according to claim 10, wherein a miscella obtained from said washing step is used as washing solvent for upstream washing step(s) and where pure solvent is used for the last washing step during said counter-current mode.

12. The process according to claim 1 wherein said basket centrifuge of step c) is an ATEX certified basket centrifuge.

13. The process according to claim 1 wherein said spinning in step c) corresponds to a centrifugal force (g-forces) comprised between 50 g and 2000 g.

14. The process according to claim 1, wherein said basket centrifuge is externally cooled.

15. The process according to claim 1, wherein said basket centrifuge is connected to an active external cooler.

16. The process according to claim 1, wherein said basket centrifuge is not externally cooled.
